(19) United States
(12) Patent Application Publication
(10) Pub. No.: US 2026/0367789 A1
(43) Pub. Date: Nov. 19, 2026

(54) MULTI-SITE DISTRIBUTED STORAGE SYSTEM HAVING A HOST PROXIMITY FEATURE

(71) Applicant: NetApp, Inc., San Jose, CA (US)

(72) Inventors: Akhil Kaushik, San Jose, CA (US); Nagaraj S. Lalsangi, Cary, NC (US); Srirama Gopal Popuri, Bangalore (IN); Joseph Sunday, Apex, NC (US); Kevin Stovall, Cary, NC (US); Daniel Gosner, Cary, NC (US)

(73) Assignee: NetApp, Inc., San Jose, CA (US)

(21) Appl. No.: 19/327,993

(22) Filed: Sep. 12, 2025

(30) Foreign Application Priority Data
May 16, 2025 (IN) 202541047124

(51) Int. Cl. G06F 3/06

(52) U.S. Cl. CPC G06F 3/061; G06F 3/065; G06F 3/067

(57) ABSTRACT

Systems and methods provide a distributed storage solution with a host proximity feature to optimize performance of IO paths between hosts and storage clusters. In one example, a computer-implemented method comprises establishing, with one or more processing resources, a first consistency group (CG1) of a first storage cluster of a first storage site and a peered consistency group (CG2) of a second storage cluster of a storage site to provide synchronous replication between one or more members of CG1 and one or more members of CG2, specifying hosts of a host group by adding hosts for the first storage cluster and the second storage cluster, and providing a host proximity property to a host record to identify one or more clusters to which a host is proximal.

### CROSS-REFERENCE TO RELATED APPLICATIONS

This application claims the benefit of priority of Indian Provisional Application No. 202541047124 filed May 16, 2025, the contents of which are hereby incorporated by reference in their entirety for all purposes.

### FIELD

Various embodiments of the present disclosure generally relate to dual copy multi-node per cluster of multi-site distributed data storage systems. In particular, some embodiments relate to methods to utilize a host proximity feature for proximity settings for hosts and multiple storage clusters of a multi-site distributed storage site in synchronous replication.

### BACKGROUND

Multiple storage nodes organized as a first storage cluster of a first storage site may store a primary copy of data while multiple storage nodes organized as a second storage cluster of a second storage site store a replicated secondary copy of the data. The distributed storage architecture is configured to service storage requests issued by one or more clients of the first and second storage clusters. The storage requests are directed to data stored on storage devices coupled to the storage nodes of the first or second storage clusters. The deployment involves the storage sites being connected via an unreliable shared network, which is prone to failures leading to connectivity issues-transient or persistent. One or more hosts communicate with the first and second storage clusters to handle input/output (I/O) operations for one or more applications of client devices. A distributed storage architecture with multiple storage sites presents challenges in providing high performance across the primary and secondary copies, due to network connectivity issues.

### SUMMARY

Systems and methods provide a distributed storage solution with a host proximity feature to improve performance of IO paths between hosts and storage clusters across a primary copy of data of a primary storage site and a secondary copy of data of a secondary storage site, both when a replication relationship is in sync and when it is out of sync between the primary and secondary storage sites. In one example, a computer-implemented method comprises establishing, with one or more processing resources, a first consistency group (CG1) of a first storage cluster of a first storage site and a peered consistency group (CG2) of a second storage cluster of a storage site to provide synchronous replication between one or more members of CG1 and one or more members of CG2, specifying hosts of a host group by adding hosts for the first storage cluster and the second storage cluster, and providing a host proximity property to a host record to identify one or more clusters to which a host is proximal. The method further comprises providing an option to edit host proximity and host group replication and setting host proximity so a correct port state and access characteristics can be reported to improve input output (IO) access performance. Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram illustrating an environment having potential failures within a multi-site distributed storage system in which various embodiments may be implemented.

FIG. 3 is a block diagram of a multi-site distributed storage system according to various embodiments of the present disclosure.

FIG. 4 is a block diagram illustrating a storage node in accordance with an embodiment of the present disclosure.

FIG. 5 is a block diagram illustrating the concept of a consistency group (CG) in accordance with an embodiment of the present disclosure.

FIG. 6A is a CG state diagram in accordance with an embodiment of the present disclosure.

FIG. 6B is a volume state diagram in accordance with an embodiment of the present disclosure.

FIG. 7 illustrates a uniform storage access configuration that is depicted as Configuration-1 in accordance with some embodiments.

FIG. 8 illustrates a non-uniform storage configuration depicted as Configuration-2 with each host (or initiator) connecting only to storage nodes on the same site as the location of the host, without any cross-site stretched paths in accordance with some embodiments.

FIG. 9 illustrates a uniform storage access configuration that is depicted as Configuration-3 in accordance with some embodiments.

FIG. 10 shows a flow diagram illustrating an order of operations of a computer-implemented method for establishing a relationship (e.g., bi-directional synchronous replication relationship) between a local CG of a first storage cluster and a peered CG of a second storage cluster and providing a host proximity feature in accordance with some embodiments of the present disclosure.

FIG. 11 shows a flow diagram illustrating an order of operations of a computer-implemented method for setting host proximity for hosts with respect to clusters of a multi-site distributed storage system in accordance with some embodiments of the present disclosure.

FIG. 12 is a block diagram illustrating a virtualized environment of a symmetric Active/Active storage system in which various embodiments may be implemented (e.g., virtual storage nodes of a primary storage site, a secondary storage site, etc.).

FIG. 13 illustrates an example computer system in which or with which embodiments of the present disclosure may be utilized.

FIG. 14 is a block diagram illustrating a cloud environment in which various embodiments may be implemented (e.g., virtual storage nodes of a primary storage site, a secondary storage site, and a tertiary storage site).

### DETAILED DESCRIPTION

Systems and methods are described for setting host proximity for hosts with respect to clusters of a multi-site distributed storage system in accordance with some embodiments of the present disclosure. A host proximity property will be used to identify one or more cluster(s) to which a host (e.g., an initiator) is proximal. The host proximal information for all hosts will be replicated to peer clusters (or peer SVMs) so that all clusters of a load-balancing relationship have a deterministic and consistent view of host proximity. The present design accurately models the possible topographies for a host (or an initiator) by allowing the host to be proximal to multiple clusters.

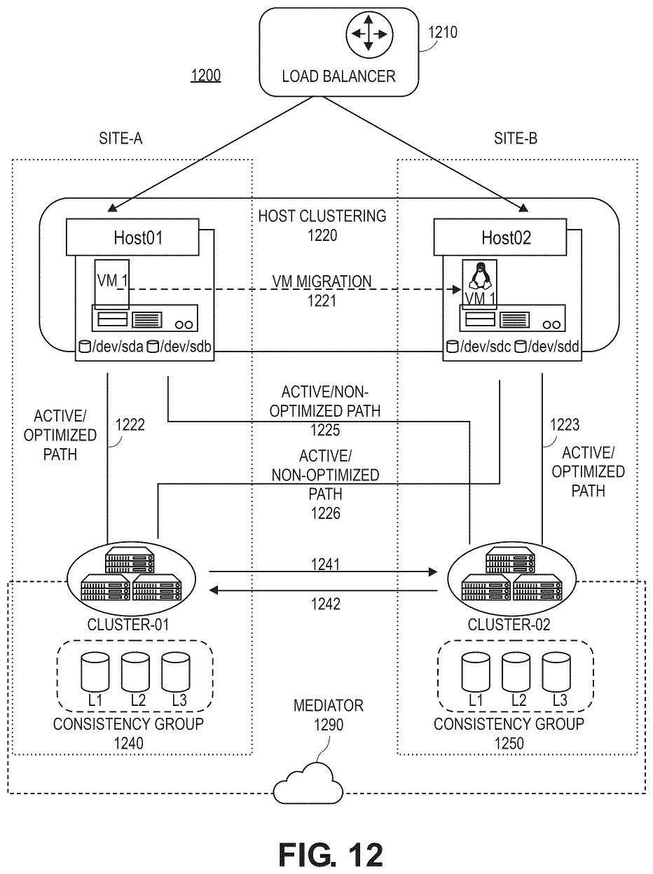

The host proximity feature can be implemented in a fully symmetric storage solution that allows simultaneous read-write access to both a primary copy and a secondary copy of data. The fully symmetric storage solution preserves dependent write order consistency between a multi-node primary storage cluster (e.g., storage cluster 135, 145, 155, 235, 245, 310, 320, 355, 510a, 510b, C1, 910) and a multi-node secondary storage cluster (e.g., storage cluster 135, 145, 155, 235, 245, 310, 320, 355, 510a, 510b, C2, 920) of a multi-site distributed storage site in synchronous replication. The fully symmetric storage solution provides application-granular zero recovery point objective (ZRPO) data protection that prevents any data loss and zero recovery time objective (ZRTO) transparent failover that provides instant recovery in the event of various potential faults for a primary storage site, a secondary storage site, and communication links between the primary and secondary storage sites. Concurrent read/write access to both copies in a symmetric Active/Active storage system is facilitated by bi-directional synchronous replication. The bi-directional synchronous replication capability of the symmetric Active/Active storage system means that any write operation (WRITE op) initiated on a primary copy of data of a first storage cluster of a first storage site is synchronously replicated to a secondary copy of data of a second storage cluster of a second storage site before a client receives an acknowledgment (ACK). Similarly, a WRITE op initiated on the secondary copy of data of the second storage cluster is synchronously replicated to the primary copy of data of the first storage cluster before the client receives an ACK. This bi-directional sync replication ensures that both primary and secondary copies are up-to-date and consistent with each other. In one example, different paths of the symmetric Active/Active storage system are illustrated in the storage system 1200 of FIG. 12.

In one example, the primary storage site and secondary storage site are located in relatively close proximity (e.g., less than 100 km, proximity based on round trip time guarantees for synchronous replication datasets) and a tertiary storage site is located at a greater distance. In another example, one or more of the storage sites (e.g., one storage site, two storage sites, three storage sites) can be located in a private or public cloud, accessible (e.g., via a web portal) to an administrator associated with a managed service provider and/or administrators of one or more customers of the managed service provider, includes a cloud-based, monitoring system provided that network connectivity is suitable for synchronous replication between the two synchronous replicated copies. Furthermore, other combinations for the storage sites are possible, for example, one storage site on premise and two storage sites in the cloud and other such variants. The three site topology is applicable to cloud-resident workloads and datasets as well. For a fully cloud resident dataset, two sites can be in the same region (e.g., same availability zone (AZ) or different AZs with sync replication being a limit to a distance between the two sites) and the third site can be in a different region (e.g., a long distance dataset copy) or even an on premise data center. Availability zones (AZs) are isolated data centers located within specific regions in which public cloud services originate and operate. Cloud computing businesses typically have multiple worldwide availability zones. A cloud-resident workload is an application, service, capability, or a specified amount of work that consumes cloud-based resources (e.g., computing or memory power). Databases, containers, microservices, VMs, and Hadoop nodes are examples of cloud workloads.

In one embodiment, cross-site high availability is a valuable addition to cross-site zero recover point objective (RPO) that provides non-disruptive operations even if an entire local data center becomes non-functional based on a seamless failing over of storage access to a mirror copy hosted in a remote data center. This type of failover is also known as zero RTO, near zero RTO, or automatic failover. A cross-site high availability storage when deployed with host clustering enables workloads to be in both data centers.

Given that more workloads are moving to a cloud environment and many customers deploy hybrid cloud, applications will also demand these same features in the cloud including cross-site high availability, planned failover, planned migration, etc.

As such, embodiments described herein seek to improve the technological processes of multi-site distributed data storage systems and overcome the above transient or persistent failures and also out of quorum (OOQ) issues. Various embodiments of the present technology provide for a wide range of technical effects, advantages, and/or improvements to multi-site distributed storage systems and components. The present storage solution provides a non-routine and unconventional components and/or operations including a host proximity feature for establishing host proximity to one or more storage clusters in order to improve IO path performance to reduce delay in serving IO to a software application of one or more client devices. Pre-existing host groups with a mix of proximal and remote initiators no longer need to be split to transition to a load-balancing mode. Load-balancing LUNs can now still report proper port states and access characteristics without requiring replicated host groups, removing a restriction from the user. Multiple (e.g., two or more clusters, three clusters, etc.) clusters can have peering relationships with overlapping hosts and configure for ALUA properly. In this present design, non-routine and unconventional components and/or operations include modifying the host configuration to be non-disruptively configurable and modifiable causing no loss of access to hosts due to not having to tear down any LUN mappings for the configuration change (e.g., host configuration change). A LUN mapping is the process of assigning a Logical Unit Number (LUN) to a specific server or host, making a storage volume (LUN) visible and accessible to that host within a storage area network (SAN). This “mapping” allows hosts to discover and use storage, enabling them to create file systems, store data, and run applications by presenting a specific LUN to a specific host entry.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### Example Operating Environment

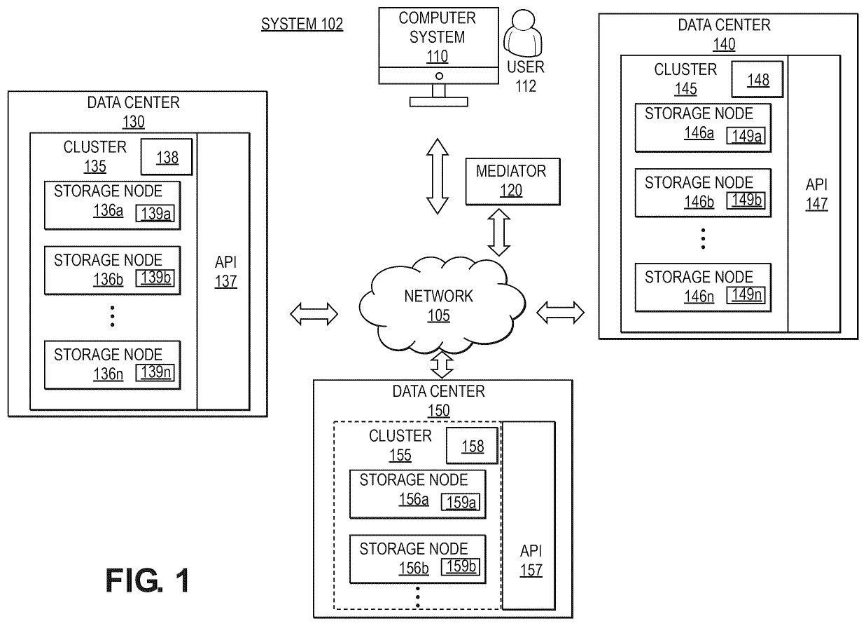

FIG. 1 is a block diagram illustrating various embodiments of a multi-site distributed storage system may be implemented. In various examples described herein, an administrator (e.g., user 112) of a multi-site distributed storage system 102 having clusters 135, 145, and optional cluster 155 or a managed service provider responsible for multiple distributed storage systems of the same or multiple customers may monitor various operations and network conditions of the distributed storage system or multiple distributed storage systems via a browser-based interface presented on computer system 110. The distributed storage system 102 provides a fully symmetric storage solution that allows simultaneous read-write access to both the primary and secondary copies of the data.

In the context of the present example, the multi-site distributed storage system 102 includes a data center 130, a data center 140, an optional data center 150, and optionally a mediator 120. The data centers 130, 140, 150, the mediator 120, and the computer system 110 are coupled in communication via a network 105, which, depending upon the particular implementation, may be a Local Area Network (LAN), a Wide Area Network (WAN), or the Internet.

The data centers 130, 140, and 150 may represent an enterprise data center (e.g., an on-premises customer data center) that is owned and operated by a company or the data center 130 may be managed by a third party (or a managed service provider) on behalf of the company, which may lease the equipment and infrastructure. Alternatively, the data centers 130, 140, and 150 may represent a colocation data center in which a company rents space of a facility owned by others and located off the company premises. The data centers are shown with a cluster (e.g., cluster 135, cluster 145, cluster 155). Those of ordinary skill in the art will appreciate additional IT infrastructure may be included within the data centers 130, 140, and 150. In one example, the data center 140 is a mirrored copy of the data center 130 to provide non-disruptive operations at all times even in the presence of failures including, but not limited to, network disconnection between the data centers 130 and 140 and the mediator 120, which can also be located at a data center. The cluster 155 of optional data center 150 can have an asynchronous relationship, synchronous relationship, or be a vault retention of the cluster 135 of the data center 130.

Turning now to the cluster 135, it includes a configuration database 138, multiple storage nodes 136a-n each having a respective mediator agent 139a-n, and an Application Programming Interface (API) 137. In the context of the present example, the multiple storage nodes 136a-n are organized as a cluster and provide a distributed storage architecture to service storage requests issued by one or more clients (not shown) of the cluster. In one example, storage nodes 136a and 136b form a first high availability (HA) node pair and nodes 136c and 136d form a second HA node pair. The configuration database may store configuration information for a cluster. A configuration database provides cluster wide storage for storage nodes within a cluster. The data served by the storage nodes 136a-n may be distributed across multiple storage units embodied as persistent storage devices, including but not limited to HDDs, SSDs, flash memory systems, or other storage devices. In a similar manner, cluster 145 includes a configuration database 148, multiple storage nodes 146a-n each having a respective mediator agent 149a-n, and an Application Programming Interface (API) 147. In the context of the present example, the multiple storage nodes 146a-n are organized as a cluster and provide a distributed storage architecture to service storage requests issued by one or more clients of the cluster. In one example, storage nodes 146a and 146b form a first high availability (HA) node pair and nodes 146c and 146d form a second HA node pair. Turning now to the optional cluster 155, it includes a configuration database 158, multiple storage nodes 156a-b each having a respective mediator agent 159a-b, and an Application Programming Interface (API) 157.

The API 137 may provide an interface through which the cluster 135 is configured and/or queried by external actors (e.g., computer system 110, data center 140, the mediator 120, clients). Depending upon the particular implementation, the API 137 may represent a Representational State Transfer (REST)ful API that uses Hypertext Transfer Protocol (HTTP) methods (e.g., GET, POST, PATCH, DELETE, and OPTIONS) to indicate its actions. Depending upon the particular embodiment, the API 137 may provide access to various telemetry data (e.g., performance, configuration, storage efficiency metrics, and other system data) relating to the cluster 135 or components thereof. As those skilled in the art will appreciate various other types of telemetry data may be made available via the API 137, including, but not limited to measures of latency, utilization, and/or performance at various levels (e.g., the cluster level, the storage node level, or the storage node component level).

In the context of the present example, the mediator 120, which may represent a private or public cloud accessible (e.g., via a web portal) to an administrator associated with a managed service provider and/or administrators of one or more customers of the managed service provider, includes a cloud-based, monitoring system.

While for sake of brevity, only three data centers are shown in the context of the present example, it is to be appreciated that additional clusters owned by or leased by the same or different companies (data storage subscribers/customers) may be monitored and one or more metrics may be estimated based on data stored within a given level of a data store in accordance with the methodologies described herein and such clusters may reside in multiple data centers of different types (e.g., enterprise data centers, managed services data centers, or colocation data centers).

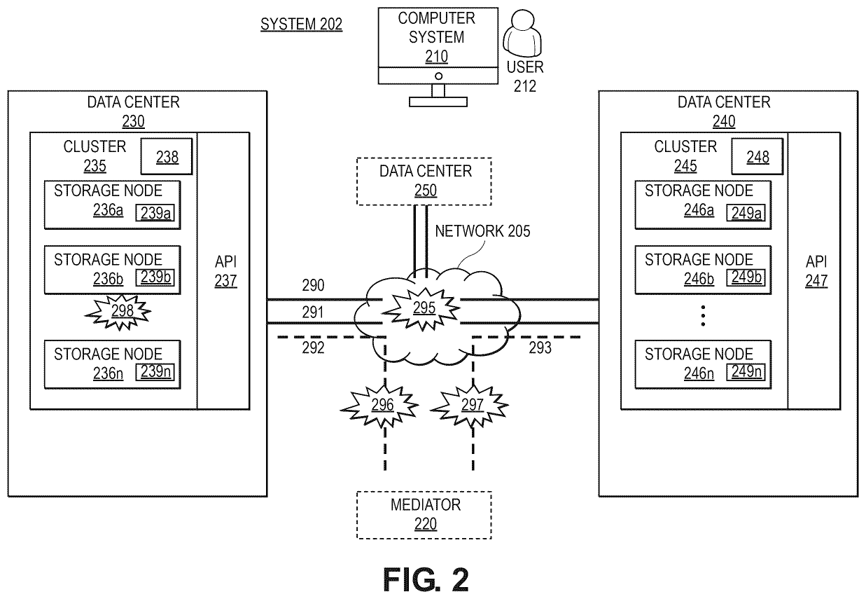

FIG. 2 is a block diagram illustrating an environment 200 having potential failures within a multi-site distributed storage system 202 in which various embodiments may be implemented. In various examples described herein, an administrator (e.g., user 212) of a multi-site distributed storage system 202 having clusters 235 and cluster 245 or a managed service provider responsible for multiple distributed storage systems of the same or multiple customers may monitor various operations and network conditions of the distributed storage system or multiple distributed storage systems via a browser-based interface presented on computer system 210.

In the context of the present example, the multi-site distributed storage system 202 includes data center 230, data center 240, an optional data center 250, and optionally a mediator 220. The data centers 230, 240, and 250, the mediator 220, and the computer system 210 are coupled in communication via a network 205, which, depending upon the particular implementation, may be a Local Area Network (LAN), a Wide Area Network (WAN), or the Internet.

The data centers 230, 240, and 250 may represent an enterprise data center (e.g., an on-premises customer data center) that is owned and operated by a company or the data center 230 may be managed by a third party (or a managed service provider) on behalf of the company, which may lease the equipment and infrastructure. Alternatively, the data centers 230, 240 and 250 may represent a colocation data center in which a company rents space of a facility owned by others and located off the company premises. The data centers 230 and 240 are shown with a cluster (e.g., cluster 235, cluster 245). The data center 250 includes similar components as data centers 230 and 240. Those of ordinary skill in the art will appreciate additional IT infrastructure may be included within the data centers 230 and 240. In one example, the data center 240 is a mirrored copy of the data center 230 to provide non-disruptive operations at all times even in the presence of failures including, but not limited to, network disconnection between the data centers 230 and 240 and the mediator 220, which can also be a data center.

The multi-site distributed storage system 202 can utilize communications 290 and 291 to synchronize a mirrored copy of data of the data center 240 with a primary copy of the data of the data center 230. Either of the communications 290 and 291 between the data centers 230 and 240 may have a failure 295. In a similar manner, a communication 292 between data center 230 and mediator 220 may have a failure 296 while a communication 293 between the data center 240 and the mediator 220 may have a failure 297. If not responded to appropriately, these failures whether transient or permanent have the potential to disrupt operations for users of the distributed storage multi-site distributed storage system 202. In one example, communications between the data centers 230 and 240 have approximately a 5-20 millisecond round trip time.

Turning now to the cluster 235, it includes a configuration database 238, at least two storage nodes 236a-b, optionally includes additional storage nodes (e.g., 236n) and an Application Programming Interface (API) 237. The storage nodes 236a-n each include a respective mediator agent 239a-n. In the context of the present example, the multiple storage nodes are organized as a cluster and provide a distributed storage architecture to service storage requests issued by one or more clients of the cluster. In one example, storage nodes 236a and 236b form a first high availability (HA) node pair and nodes 236c and 136d form a second HA node pair. The nodes 236a and 236b may be OOQ and not able to communicate with other nodes in cluster 235 due to failure 298. The data served by the storage nodes may be distributed across multiple storage units embodied as persistent storage devices, including but not limited to HDDs, SSDs, flash memory systems, or other storage devices.

Turning now to the cluster 245, it includes a configuration database 248, at least two storage nodes 246a-b, optionally includes additional storage nodes (e.g., 246n) and includes an Application Programming Interface (API) 247. The storage nodes 246a-n each include a respective mediator agent 249a-n. In the context of the present example, the multiple storage nodes are organized as a cluster and provide a distributed storage architecture to service storage requests issued by one or more clients of the cluster. In one example, storage nodes 246a and 246b form a first high availability (HA) node pair and nodes 246c and 246d form a second HA node pair. The data served by the storage nodes may be distributed across multiple storage units embodied as persistent storage devices, including but not limited to HDDs, SSDs, flash memory systems, or other storage devices.

A synchronous replication from a primary copy of data at a primary storage site (e.g., cluster 235) to a secondary copy of data at a secondary storage site (e.g., cluster 245) can fail due to inter cluster or cluster to mediator connectivity issues (e.g., failures 295, 296, 297). These issues can occur if the secondary storage site can not differentiate between the primary storage site being non-operational (or isolation), or just a network partition. A trigger for the automated failover is generated from a data path and if the data path is lost, this can lead to disruption. A data replication relationship between the primary and secondary storage sites guarantees non-disruptiveness due to allowing I/O operations to be handled with the secondary mirror copy of data. However, there are timing windows between the primary storage site being non-operational and the secondary mirror copy being ready to serve I/O operations where a second failure can lead to disruption. For example, a controller failure can occur in a cluster hosting the secondary mirror copy of the data. The C-OOS feature having accounting for all members of a group of storage nodes of the present design guarantees dependent write order consistency even in the presence of these multiple failures.

In one example, each cluster can have up to 5 consistency groups with each consistency group having up to 12 volumes. The multi-site distributed storage system 202 provides an automatic unplanned failover feature at a consistency group granularity. The failover feature allows switching storage access from a primary copy of the data center 230 to a mirror copy of the data center 240 or vice versa.

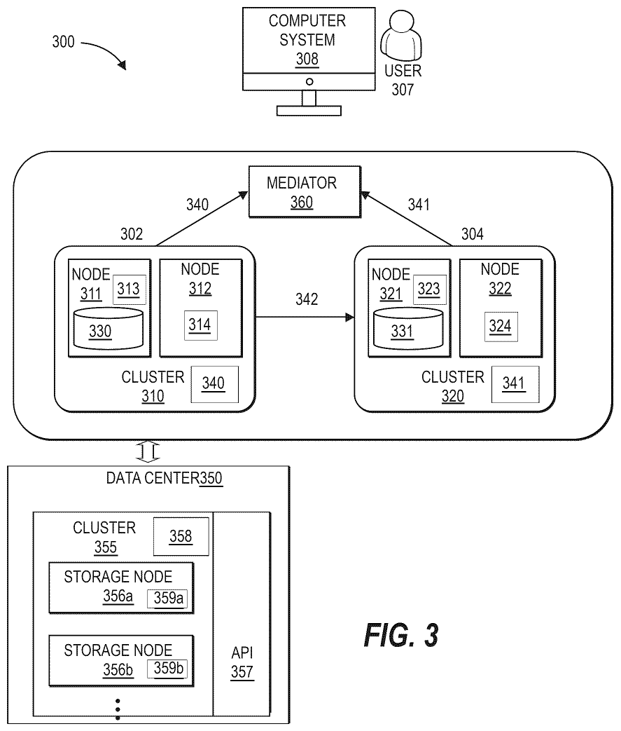

FIG. 3 is a block diagram illustrating a multi-site distributed storage system 300 in which various embodiments may be implemented. In various examples described herein, an administrator (e.g., user 307) of the multi-site distributed storage system 300 or a managed service provider responsible for multiple distributed storage systems of the same or multiple customers may monitor various operations and network conditions of the distributed storage system or multiple distributed storage systems via a browser-based interface presented on computer system 308. In the context of the present example, the distributed storage system 300 includes a data center 302 having a cluster 310, a data center 304 having a cluster 320, an optional data center 350 having a cluster 355, and a mediator 360. The clusters 310, 320, 355, and the mediator 360 are coupled in communication (e.g., communications 340-342) via a network, which, depending upon the particular implementation, may be a Local Area Network (LAN), a Wide Area Network (WAN), or the Internet.

The cluster 310 includes nodes 311 and 312, the cluster 320 includes nodes 321 and 322, and the optional cluster 355 includes nodes 356a and 356b. In one example, the cluster 320 has a data copy 331 that is a mirrored copy of the data copy 330 to provide non-disruptive operations at all times even in the presence of multiple failures including, but not limited to, network disconnection between the data centers 302 and 304 and the mediator 360. The cluster 355 may have an asynchronous replication relationship with cluster 310 or a mirror vault policy. The cluster 355 includes a configuration database 358, multiple storage nodes 356a-b each having a respective mediator agent 359a-b, and an Application Programming Interface (API) 357. For an asynchronous replication relationship, asynchronous mirroring copies data volumes on demand or on a schedule, which minimizes or avoids downtime that might result from data corruption or loss. Asynchronous mirroring captures the state of the primary volume at a particular point in time and copies just the data that has changed since the last image capture. The primary site can be updated immediately and the secondary site can be updated as bandwidth allows. The information is cached and sent later, as network resources become available. This type of mirroring is ideal for satisfying the demand for non-stop operations and, in general, is far more network efficient for periodic processes, such as backup and archive.

A mirror vault policy provides unified data protection, supporting both disaster recovery (DR) and backup/archival using a single replication relationship. The mirror vault policy allows for the replication of snapshots from a source volume (e.g., originating volume having original copy of data) to a destination volume, retaining a longer history of point-in-time snapshots on the destination for backup and compliance, while also enabling DR recovery.

The multi-site distributed storage system 300 provides correctness of data, availability, and redundancy of data. In one example, the node 311 is designated as a leader and the node 321 is designated as a follower. The leader is given preference to serve I/O operations to requesting clients and this allows the leader to obtain a consensus in a case of a race between the clusters 310 and 320. The mediator 360 enables an automated unplanned failover (AUFO) in the event of a failure. The data copy 330 (leader), data copy 331 (follower), and the mediator 360 form a three way quorum. If two of the three entities reach an agreement for whether the leader or follower should serve I/O operations to requesting clients, then this forms a strong consensus.

The leader and follower roles for the clusters 310 and 320 help to avoid a split-brain situation with both of the clusters simultaneously attempting to serve I/O operations. For example, the leader may become unresponsive while a mediator detects this unresponsiveness to be a leader non-operational situation. The leader being non-operational can potentially cause a race between leader and follower copy both simultaneously attempting to obtain a consensus. However, only one of the leader and the follower should win the race and then be allowed to handle I/O operations. If this race is not prevented, it can result in the split-brain situation.

There are scenarios where both leader and follower copies can claim to be a leader copy. In one example, a follower cannot serve I/O until an AUFO happens. A leader doesn't serve I/O operations until the leader obtains a consensus.

The mediator agents (e.g., 313, 314, 323, 324, 359a, 359b) are configured on each node within a cluster. The system 300 can perform appropriate actions based on event processing of the mediator agents. The mediator agent(s) processes events that are generated at a lower level (e.g., volume level, node level) and generates an output for a consistency group level. In one example, the nodes 311, 312, 321, and 322 form a consistency group. The mediator agent provides services for various events (e.g., simultaneous events, conflicting events) generated in a business data replication relationship between each cluster.

The multi-site distributed storage system 300 presents a single virtual logical unit number (LUN) to a host computer or client using a synchronized-replicated distributed copies of a LUN. A LUN is a unique identifier for designating an individual or collection of physical or virtual storage devices that execute input/output (I/O) commands with a host computer, as defined by the Small System Computer Interface (SCSI) standard. In one example, active or passive access to this virtual LUN causes read and write commands to be serviced only by node 311 (leader) while operations received by the node 321 (follower) are proxied to node 311.

### Example Storage Node

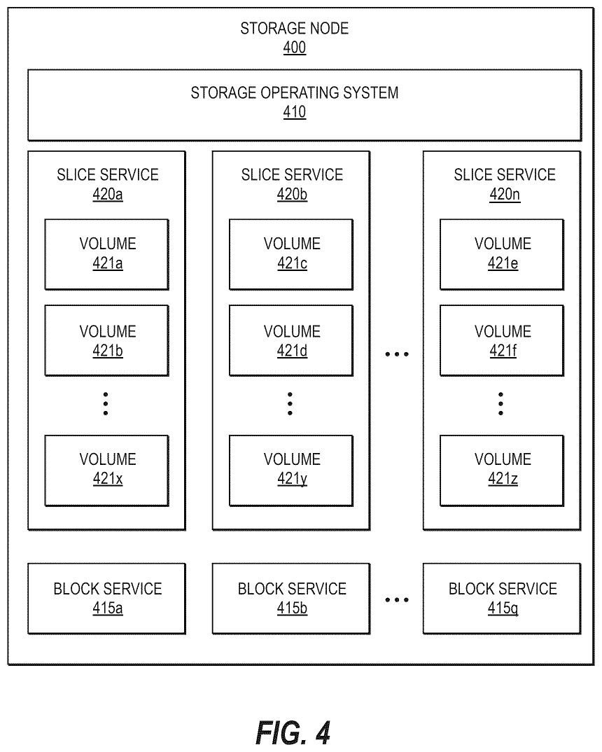

FIG. 4 is a block diagram illustrating a storage node 400 in accordance with an embodiment of the present disclosure. Storage node 400 represents a non-limiting example of storage nodes (e.g., 136a-n, 146a-n, 236a-n, 246a-n, 311, 312, 331, 322, 712, 714, 752, 754) described herein. In the context of the present example, a storage node 400 may be a network storage controller or controller that provides access to data stored on one or more volumes. The storage node 400 includes a storage operating system 410, one or more slice services 420a-n, and one or more block services 415a-q. The storage operating system (OS) 410 may provide access to data stored by the storage node 400 via various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. A non-limiting example of the storage OS 410 is NetApp Element Software (e.g., the SolidFire Element OS) based on Linux and designed for SSDs and scale-out architecture with the ability to expand up to 100 storage nodes.

Each slice service 420 may include one or more volumes (e.g., volumes 421a-x, volumes 421c-y, and volumes 421e-z). Client systems (not shown) associated with an enterprise may store data to one or more volumes, retrieve data from one or more volumes, and/or modify data stored on one or more volumes.

The slice services 420a-n and/or the client system may break data into data blocks. Block services 415a-q and slice services 420a-n may maintain mappings between an address of the client system and the eventual physical location of the data block in respective storage media of the storage node 400. In one embodiment, volumes 421 include unique and uniformly random identifiers to facilitate even distribution of a volume's data throughout a cluster (e.g., cluster 135). The slice services 420a-n may store metadata that maps between client systems and block services 415. For example, slice services 420 may map between the client addressing used by the client systems (e.g., file names, object names, block numbers, etc. such as Logical Block Addresses (LBAs)) and block layer addressing (e.g., block IDs) used in block services 415. Further, block services 415 may map between the block layer addressing (e.g., block identifiers) and the physical location of the data block on one or more storage devices. The blocks may be organized within bins maintained by the block services 415 for storage on physical storage devices (e.g., SSDs).

As noted above, a bin may be derived from the block ID for storage of a corresponding data block by extracting a predefined number of bits from the block identifiers. In some embodiments, the bin may be divided into buckets or “sublists” by extending the predefined number of bits extracted from the block identifier. A bin identifier may be used to identify a bin within the system. The bin identifier may also be used to identify a particular block service 415a-q and associated storage device (e.g., SSD). A sublist identifier may identify a sublist with the bin, which may be used to facilitate network transfer (or syncing) of data among block services in the event of a failure or crash of the storage node 400. Accordingly, a client can access data using a client address, which is eventually translated into the corresponding unique identifiers that reference the client's data at the storage node 400.

For each volume 421 hosted by a slice service 420, a list of block IDs may be stored with one block ID for each logical block on the volume. Each volume may be replicated between one or more slice services 420 and/or storage nodes 400, and the slice services for each volume may be synchronized between each of the slice services hosting that volume. Accordingly, failover protection may be provided in case a slice service 420 fails, such that access to each volume may continue during the failure condition.

### Consistency Groups

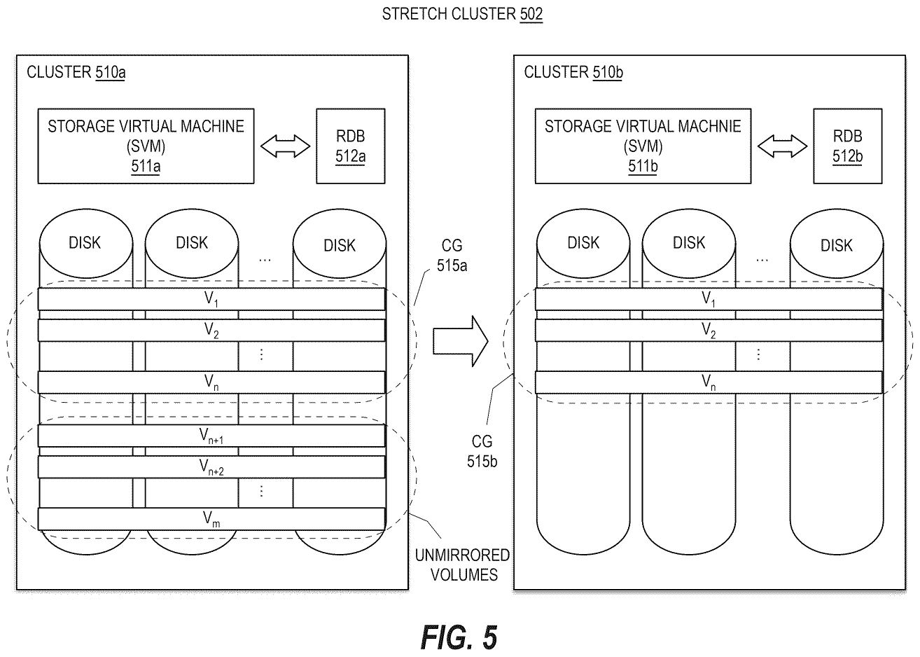

FIG. 5 is a block diagram illustrating the concept of a consistency group (CG) in accordance with an embodiment of the present disclosure. In the context of the present example, a stretch cluster 502 including two clusters (e.g., cluster 510a and 510b) is shown. The clusters may be part of a cross-site high-availability (HA) solution that supports zero recovery point objective (RPO) and zero recovery time objective (RTO) protections by, among other things, providing a mirror copy of a dataset at a remote location, which is typically in a different fault domain than the location at which the dataset is hosted. For example, cluster 510a may be operable within a first site (e.g., a local data center) and cluster 510b may be operable within a second site (e.g., a remote data center) so as to provide non-disruptive operations even if, for example, an entire data center becomes non-functional, by seamlessly failing over the storage access to the mirror copy hosted in the other data center.

According to some embodiments, various operations (e.g., data replication, data migration, data protection, failover, storage expansion, container expansion, conversion process, and the like) may be performed at the level of granularity (e.g., grouping of storage objects or data containers) of a CG (e.g., CG 515a or CG 515b). A CG is a collection of storage objects or data containers (e.g., volumes V1, V2, . . . Vn, Vn+1, Vn+2, . . . Vm) that are managed or treated as a single unit for replication purposes. This ensures that the data across all volumes remains consistent and synchronized. In one example, the data of the storage objects or data containers for an application is f managed by a Storage Virtual Machine (e.g., SVM 511a or SVM 511b) as a single unit. In various embodiments, the use of a CG as a unit of data replication guarantees a dependent write-order consistent view of the dataset and the mirror copy to support zero RPO and zero RTO. CGs may also be configured for use in connection with taking simultaneous snapshot images of multiple volumes, for example, to provide crash-consistent copies of a dataset associated with the volumes at a particular point in time.

In various examples described herein, a storage device (or “disk”) may be used interchangeably throughout this specification. Alternatively, storage devices other than disks may be utilized, e.g., flash memory, optical storage, solid state devices, etc. As such, the description of disks should be taken as exemplary only. Information may be stored on any type of attached array of writable storage device media such as video tape, optical, DVD, magnetic tape, bubble memory, electronic random access memory, micro-electromechanical and any other similar media adapted to store information, including data and parity information. The volumes of a CG may span multiple storage devices (e.g., electromechanical disks and/or SSDs, redundant array of independent (RAID) disks) of one or more storage nodes of the cluster. RAID disks store the same data in different place on multiple hard disks or SSDs to protect data in case of a drive failure. A CG may include a subset or all volumes of one or more storage nodes. In one example, a CG includes a subset of volumes of a first storage node and a subset of volumes of a second storage node. In another example, a CG includes a subset of volumes of a first storage node, a subset of volumes of a second storage node, and a subset of volumes of a third storage node. A CG may be referred to as a local CG or a remote CG depending upon the perspective of a particular cluster. For example, CG 515a may be referred to as a local CG from the perspective of cluster 510a and as a remote CG from the perspective of cluster 510b. Similarly, CG 515a may be referred to as a remote CG from the perspective of cluster 510b and as a local CG from the perspective of cluster 510a. At times, the volumes (e.g., volumes V1, V2, . . . Vn; unmirrored volumes Vn+1, Vn+2, . . . Vm) of a CG may be collectively referred to herein as members of the CG and may be individually referred to as a member of the CG. In one embodiment, members may be added or removed from a CG after it has been created.

A cluster may include one or more SVMs, each of which may contain data volumes and one or more logical interfaces (LIFs) (not shown) through which they serve data to clients. SVMs may be used to securely isolate the shared virtualized data storage of the storage nodes in the cluster, for example, to create isolated partitions within the cluster. In one embodiment, an LIF includes an Internet Protocol (IP) address and its associated characteristics. Each SVM may have a separate administrator authentication domain and can be managed independently via a management LIF to allow, among other things, definition and configuration of the associated CGs.

In the context of the present example, the SVMs make use of a configuration database (e.g., replicated database (RDB) 512a and 512b), which may store configuration information for their respective clusters. A configuration database provides cluster wide storage for storage nodes within a cluster.

The configuration information may include data replication relationship information specifying the data replication status (e.g., insync state, out of sync state, not ready for resync, ready for resync), direction of data replication (e.g., forward directional from primary storage site to secondary storage site, reverse directional from secondary storage site to primary storage site), relationships (e.g., unidirectional synchronous replication, bidirectional synchronous replication, asynchronous replication, unified replication for mirror vault policy), and/or roles of individual CGs (e.g., primary role for serving I/O operations of an application, secondary role for serving I/O operations of an application), a set of CGs to be selected by an administrator based on storage requirements for an application, members of the CGs, and/or the mediator.

The level of granularity of operations supported by a CG is useful for various types of applications. As a non-limiting example, consider an application, such as a database application, that makes use of multiple volumes of a local CG, including maintaining logs on one volume and the database on another volume. In such a case, the application may be assigned to the local CG of a first storage cluster that maintains the primary dataset, including an appropriate number of member volumes to meet the needs of the application, and a remote CG, for maintaining a mirror copy of the primary dataset, may be established on a second storage cluster to protect the local CG. The level of granularity of operations allows a single operation to be performed on all volumes or subset of volumes of a CG to more efficiently manage operations of the volumes.

While in the context of various embodiments described herein, a volume of a CG may be described as performing certain actions (e.g., taking other members of a CG out of synchronization, disallowing/allowing access to the dataset or the mirror copy, issuing consensus protocol requests, etc.), it is to be understood such references are shorthand for an SVM or other controlling entity, managing or containing the volume at issue, performing such actions on behalf of the volume.

While in the context of various examples described herein, data replication may be described as being performed in a synchronous manner between a paired set of (or “peered”) CGs associated with different clusters (e.g., from a primary cluster to a secondary cluster), data replication may also be performed asynchronously and/or within the same cluster. Similarly, a single remote CG may protect multiple local CGs and/or multiple remote CGs may protect a single local CG. For example, a local CG can be setup for double protection by two remote CGs via fan-out or cascade topologies. In addition, those skilled in the art will appreciate a cross-site high-availability (HA) solution may include more than two clusters, in which a mirrored copy of a dataset of a primary cluster is stored on more than one secondary cluster.

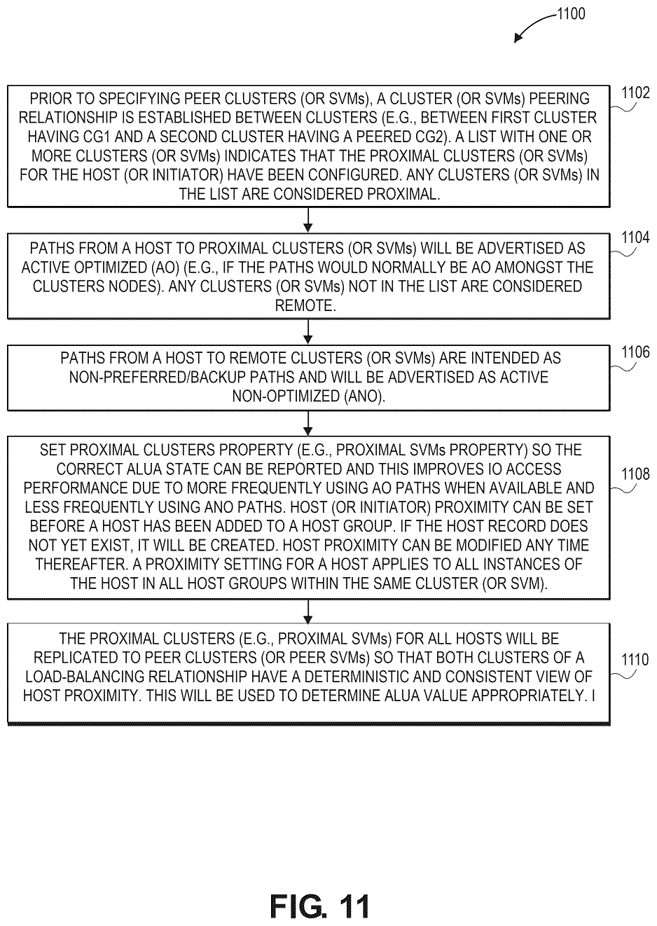

The various nodes (e.g., storage nodes) of the distributed storage systems described herein, and the processing described below with reference to the flow diagrams of FIGS. 10-11 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems (e.g., servers, network storage systems or appliances, blades, etc.) of various forms, such as the computer system described with reference to FIG. 10 below.

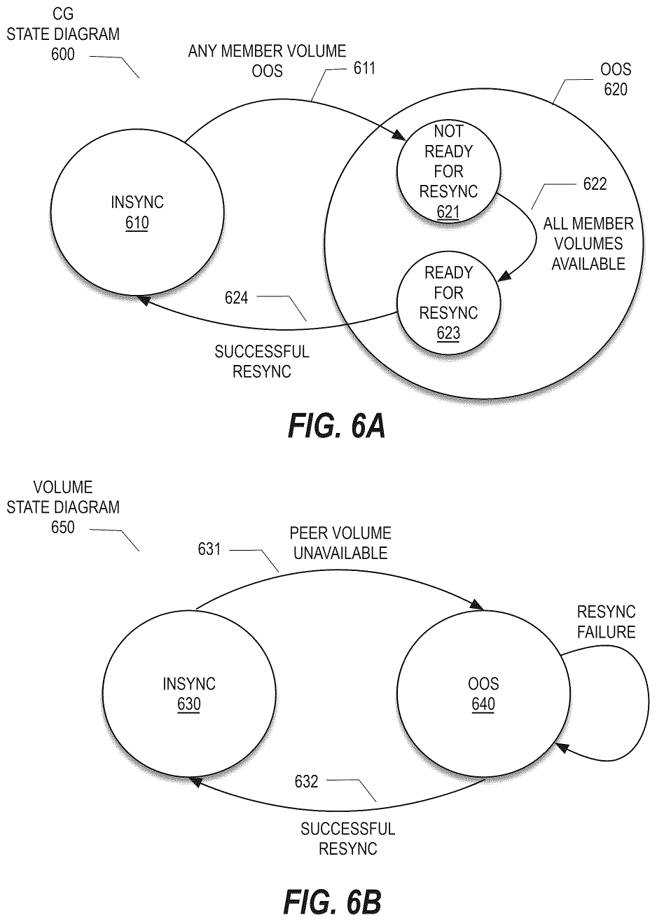

FIG. 6A is a CG state diagram 600 in accordance with an embodiment of the present disclosure. In the context of the present example, the data replication status of a CG can generally be in either of an InSync state (e.g., InSync 610) or an OOS state (e.g., OOS 620). Within the OOS state, two sub-states are shown, a not ready for resync state 621 and a ready for resync state 623.

While a given CG is in the InSync state, the mirror copy of the primary dataset associated with the member volumes of the given CG may be said to be in-synchronization with the primary dataset and asynchronous data replication or synchronous data replication, as the case may be, are operating as expected. When a given CG is in the OOS state, the mirror copy of the primary dataset associated with the member volumes of the given CG may be said to be out-of-synchronization with the primary dataset and asynchronous data replication or synchronous data replication, as the case may be, are unable to operate as expected. Information regarding the current state of the data replication status of a CG may be maintained in a configuration database (e.g., RDB 512a or 512b).

As noted above, in various embodiments described herein, the members (e.g., volumes) of a CG may be managed as a single unit for various situations. In the context of the present example, the data replication status of a given CG is dependent upon the data replication status of the individual member volumes of the CG. A given CG may transition 611 from the InSync state to the not ready for resync state 621 of the OOS state responsive to any member volume of the CG becoming OOS with respect to a peer volume with which the member volume is peered. A given CG may transition 622 from the not ready for resync state 621 to the ready for resync state 623 responsive to all member volumes being available. In order to support recovery from, among other potential disruptive events, manual planned disruptive events (e.g., balancing of CG members across a cluster) a resynchronization process is provided to bring the CG back into the InSync state from the OOS state. Responsive to a successful CG resync, a given CG may transition 624 from the ready for resync state 623 to the InSync state.

For completeness it is noted that additional state transitions may exist. For example, in some embodiments, a given CG may transition from the ready for resync state 623 to the not ready for resync state 621 responsive to unavailability of a mediator (e.g., mediator 120) configured for the given CG. In such an embodiment, the transition 622 from the not ready for resync state 621 to the ready for resync state 623 should additionally be based on the communication status of the mediator being available.

FIG. 6B is a volume state diagram 650 in accordance with an embodiment of the present disclosure. In the context of the present example, the data replication status of a volume can be in either of an InSync state (e.g., InSync 630) or an OOS state (e.g., OOS 640). While a given volume of a local CG (e.g., CG 515a) is in the InSync state, the given volume may be said to be in-synchronization with a peer volume of a remote CG (e.g., CG 515b) and the given volume and the peer volume are able to communicate with each other via the potentially unreliable network (e.g., network 205), for example, through their respective LIFs. When a given volume of the local CG is in the OOS state, the given volume may be said to be out-of-synchronization with the peer volume of the remote CG and the given volume and the peer volume are unable to communicate with each other. According to one embodiment, a periodic health check task may continuously monitor the ability to communicate between a pair of peered volumes. Information regarding the current state of the data replication status of a volume may be maintained in a configuration database (e.g., RDB 512a or 512b).

A given volume may transition 631 from the InSync state to the OOS state responsive to a peer volume being unavailable. A given volume may transition 632 from the OOS state to the InSync state responsive to a successful resynchronization with the peer volume. As described below in further detail, in one embodiment, two different types of resynchronization approaches may be implemented, including a Fast Resync process and a CG-level resync process, and selected for use individually or in sequence as appropriate for the circumstances.

In one example, a Fast Resync process is based on reestablishing a Sync Data Path between a data copy of a node of a primary storage cluster having a primary role and a mirrored data copy of a mirrored node of a secondary storage cluster having a secondary role, and reconciling inflight regions based on persistent inflight tracking of I/O operations (IFT-P). The secondary storage cluster can be provided with information (e.g., configuration information, inflight ops from primary storage cluster being replayed and tracked on secondary storage cluster, utilize block-level metadata to identify differences between Snapshot copies of the primary storage cluster and the secondary storage cluster at the indirect pointer level, enabling efficient data transfer and resynchronization) about a high availability partner to avoid cross-cluster calls between the primary and secondary storage cluster. Note, no asynchronous transfers and transitions are allowed during the Fast Resync, which will establish a transfer engine session and start persistent inflight operation (op) tracking replay. A Fast Resync can be triggered as soon a storage object on the secondary storage cluster is mounted.

### Host Proximity Feature

The present design provides a host proximity feature while allowing read-write access to both copies of a distributed storage system. A host and initiator are used interchangeably in the present disclosure. A host property (or initiator property) will be used to identify one or more cluster(s) to which a host (e.g., an initiator) is proximal having a local proximity.

A symmetric Active/Active storage solution allows simultaneous read-write access to both a primary copy of data on a primary storage site and a secondary copy of the data on a secondary storage site. The concurrent read/write access to both copies of data in the Active/Active system is facilitated by bi-directional synchronous replication.

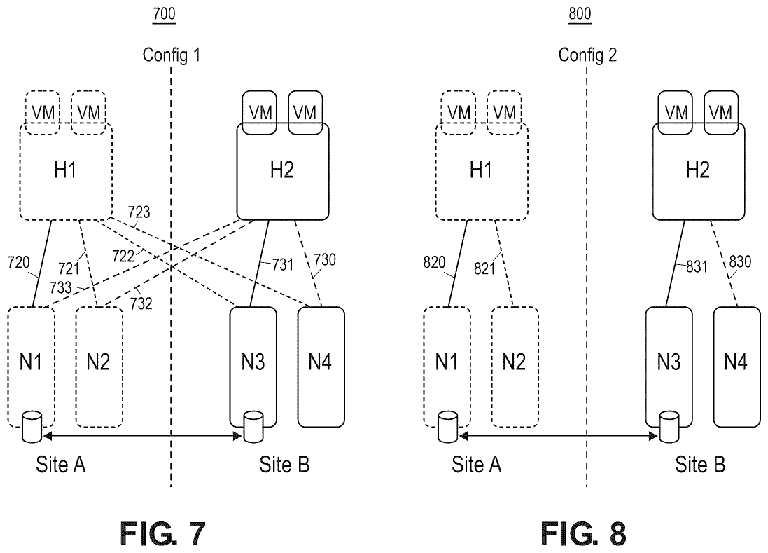

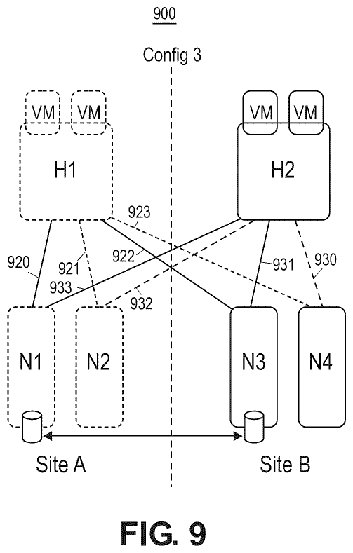

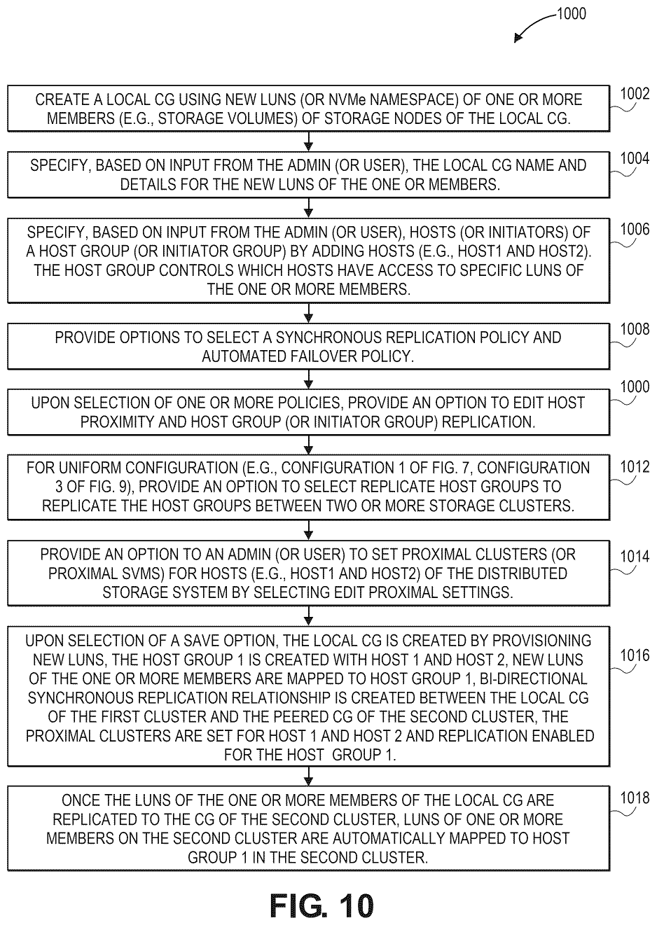

Hosts (e.g., H1, H2, Host 01, Host 02) of FIGS. 7-9 can access storage volumes using either a uniform or non-uniform storage area network (SAN) connectivity topology. A SAN is a computer network that provides access to consolidated, block-level data storage. In a uniform storage access configuration for system 700 that is depicted as Configuration-1 in FIG. 7, each host (e.g., H1, H2) or initiator has connectivity through all available paths to both storage sites, with cross-site paths stretched across distances. The paths (e.g., 720-723, 730-733) are displayed as dashed or solid lines between a host and a node (e.g., N1, N2, N3, N4). In a non-uniform storage configuration for system 800 depicted as Configuration-2 in FIG. 8, each host (or initiator) connects only to storage nodes on the same site as the location of the host, without any cross-site stretched paths. To support a load balancing mode, site locality aware ALUA characteristics are needed. Site locality aware ALUA is achieved via the host proximity feature in which an administrator (admin) will be provided with an option to chose one or more storage clusters that are local to one or more host(s).

When a multipath enabled host is connected for uniform storage access, the host will distribute its IOs across the local active/optimized paths based on its path selection policy, such as round robin (RR) or least queue depth (LQD). In cases with no active/optimized paths being available, the host's multipathing software will utilize the active/non-optimized paths to maintain access to the storage volumes of a node.

Active Optimized paths are a path state in ALUA (Asymmetric Logical Unit Access) where the target storage system responds to I/O requests using the most efficient path. ALUA also known as Target Port Groups Support (TPGS), is a set of SCSI concepts and commands that define path prioritization for SCSI devices. ALUA is a formalized way to describe SCSI port status and access characteristics. In short, ALUA describes paths as fast, slow, or down and the transitions between these states in a standards-compliant manner. This standard is designed to define the protocol on how multipath IO should be managed between hosts and storage devices.

In this case, the active/optimized path 720, 721 is between host H1 and nodes N1 and N2 at site A while the active/non-optimized path 722 and 723 is between host H1 and nodes N3 and N4 at site B. Also, the active/optimized path 730, 731 is between host H2 and nodes N3 and N4 at site B while the active/non-optimized path 732 and 733 is between host H2 and nodes N1 and N2 at site A. The active non-optimized paths are between different sites.

In the case of a host connected for non-uniform storage access as illustrated in FIG. 8, the host will distribute its IOs across the local active/optimized paths 820, 821 and 830, 831 based on its path selection policy. However, it is important to note that such a host does not have access to the remote storage from a remote storage site.

In a uniform storage access configuration for system 900 that is depicted as Configuration-3 in FIG. 9, each host (e.g., H1, H2) or initiator has connectivity through all available paths to both storage sites, with cross-site paths stretched across distances. The paths (e.g., 920-923, 930-933) are displayed as dashed or solid lines between a host and a node (e.g., N1, N2, N3, N4). If host proximity is not set or both H1 and H2 in the FIG. 9 are configured as proximity to both sites it is possible to achieve config 3.

When a multipath enabled host is connected for uniform storage access, it will distribute its IOs across the local active/optimized paths based on its path selection policy, such as round robin (RR) or least queue depth (LQD). In cases with no active/optimized paths being available, the host's multipathing software will utilize the active/non-optimized paths to maintain access to the storage volumes of a node.

Active Optimized paths are a path state in ALUA (Asymmetric Logical Unit Access) where the target storage system responds to I/O requests using the most efficient path. In this case, the active/optimized path 920, 921 is between host H1 and nodes N1 and N2 at site A while the active/non-optimized path 922 and 923 is between host H1 and nodes N3 and N4 at site B. Also, the active/optimized path 930, 931 is between host H2 and nodes N3 and N4 at site B while the active/non-optimized path 932 and 933 is between host H2 and nodes N1 and N2 at site A. The active non-optimized paths are between different sites.

Designing a fully functional Active/Active multi-site solution with bi-directional replication from an active SAN workload in non-disruptive manner presents several design challenges that needs to be addressed.

In an Active/Active storage solution, both the storage copies should function in read-write mode, unlike a read-write/read-only mode for an Active/Passive solution. Bi-directional replication should guarantee that any changes made to the data on either side are synchronously replicated to the other copy, ensuring that both storage copies remain identical. To achieve optimal performance in active/active environments, it is important that both sites report consistent ALUA state so that all paths are exposed as Active/Optimized path. The present storage solution is able to establish bi-directional replication for existing standalone SAN workload in non-disruptive manner to the hosts and the application and at a same time maintain data consistency across both copies of a data set.

When an admin (or user) provisions storage, this enables SAN hosts to read from and write data to storage systems. To provision storage, a System Manager is used to create storage units, add host initiators, and map the host to a storage unit. For creating storage units, a storage unit makes storage space available to SAN hosts for data operations. A storage unit refers to a LUN for SCSI hosts or a NVMe namespace for NVMe hosts. If a cluster is configured to support SCSI hosts, an admin is prompted to create a LUN. If a cluster is configured to support NVMe hosts, the admin is prompted to create an NVMe namespace. The nonvolatile memory express (NVMe) protocol is a transport protocol used for accessing nonvolatile storage media. The non-volatile memory express (NVMe) protocol provides storage in a SAN environment. The NVMe protocol is optimized for performance with solid state storage.

For NVMe, storage targets are called namespaces. An NVMe namespace is a quantity of non-volatile storage that can be formatted into logical blocks and presented to a host as a standard block device. An admin creates namespaces and subsystems, and then maps the namespaces to the subsystems, similar to the way LUNs are provisioned and mapped to host groups for FC and iSCSI. NVMe targets are connected to the network through a standard FC infrastructure using FC switches or a standard TCP infrastructure using Ethernet switches and host-side adapters.

FIG. 10 shows a flow diagram illustrating an order of operations of a computer-implemented method for establishing a relationship (e.g., bi-directional synchronous replication relationship) between a local CG of a first storage cluster and a peered CG of a second storage cluster and providing a host proximity feature in accordance with some embodiments of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote peered CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 1000 are shown in a particular order, the order of the actions can be modified. Thus, the illustrated embodiments can be performed in a different order, and some operations may be performed in parallel. Some of the operations listed in FIG. 10 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1000 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), one or more storage nodes (e.g., 139a-139n, 149a-149n, 159a-159n, 239a-239n, 249a-249n, 311, 312, 321, 322, 359a-359n, etc.), one or more storage clusters (e.g., 135, 145, 155, 235, 245, 310, 320, 355, 510a, 510b, cluster 01, cluster 02, etc.) of a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system (e.g., systems 102, 202, 300, 700, 800, 900, 1200, 2900, etc.) includes the primary storage site (e.g., site A) having a first storage cluster with a primary copy of data in a consistency group (CG1). The first storage cluster includes multiples nodes and can include nodes 1 and 2 forming a first HA node pair. Alternatively, the first storage cluster includes nodes 1 and 2 forming a first HA pair and nodes 3 and 4 forming a second HA node pair. The consistency group of the first storage cluster is initially assigned a primary role. A second storage cluster (e.g., site B) of the secondary storage site has a secondary mirror copy of the data in a consistency group. The consistency group of the second storage cluster (CG2) is initially assigned a secondary role. The second storage cluster also includes multiples nodes and at least one HA node pair. The storage system handles input/output (I/O) requests from one or more client devices that have one or more installed software applications. The primary storage site and secondary storage site communicate via a network that is prone to failures.

Initially, at operation 1002, the computer-implemented method creates the local CG using new LUNs (or NVMe namespace) of one or more members (e.g., storage volumes) of storage nodes (e.g., nodes 1-2, nodes 3-4, etc.) of the local CG. At operation 1004, the computer-implemented method based on input from the admin (or user) specifies the local CG name and details for the new LUNs (or NVMe namespace) of the one or members. At operation 1006, the computer-implemented method based on input from the admin (or user) specifies Hosts (or initiators) of a host group (or initiator group) by adding hosts (e.g., host1 and host2). The host group controls which hosts have access to specific LUNs (or NVMe namespace) of the one or more members. At operation 1008, the computer-implemented method provides options to select a synchronous replication policy and automated failover policy. At operation 1010, upon selection of one or more policies, the computer-implemented method will provide an option to edit host proximity and host group (or initiator group) replication. For uniform configuration (e.g., configuration 1 of FIG. 7, configuration 3 of FIG. 9), the computer-implement method at operation 1012 provides an option to select replicate host groups to replicate the host groups between two or more storage clusters. The computer-implement method at operation 1014 provides an option to an admin (or user) to set proximal clusters (or proximal SVMs) for hosts (e.g., host1 and host2) of the distributed storage system by selecting edit proximal settings.

Upon selection of a save option at operation 1016, the local CG is created by provisioning new LUNs (or NVMe namespace), the host group 1 is created with host 1 and host 2, new LUNs of the one or more members are mapped to host group 1, bi-directional synchronous replication relationship is created between the local CG of the first storage cluster and the peered CG of the second storage cluster, the proximal clusters are set for host 1 and host 2 and replication enabled for the host group 1. At operation 1018, once the LUNs (or NVMe namespace) of the one or more members of the local CG are replicated to the CG of the second storage cluster, LUNs (or NVMe namespace) of one or more members on the second storage cluster are automatically mapped to host group 1 in the second storage cluster.

FIG. 11 shows a flow diagram illustrating an order of operations of a computer-implemented method for setting host proximity for hosts with respect to clusters of a multi-site distributed storage system in accordance with some embodiments of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote peered CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 1100 are shown in a particular order, the order of the actions can be modified. Thus, the illustrated embodiments can be performed in a different order, and some operations may be performed in parallel. Some of the operations listed in FIG. 11 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1100 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), one or more storage nodes (e.g., 139a-139n, 149a-149n, 159a-159n, 239a-239n, 249a-249n, 311, 312, 321, 322, 359a-359n, etc.), one or more storage clusters (e.g., 135, 145, 155, 235, 245, 310, 320, 355, 510a, 510b, cluster 01, cluster 02, etc.) of a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

At operation 1102, a new host proximity property (e.g., proximal clusters, proximal SVMs) is added to a host record (e.g., initiator record). This property will be used to identify one or more cluster(s) to which a host (e.g., an initiator) is proximal. Host properties can be tracked as proximal SVMs or proximal cluster(s). In one example, a host property is a list to enable accurate modeling of multiple clusters accessed by the same host (e.g., initiator) on a shared network. The host proximity property can contain zero or more clusters (or SVMs). An empty list indicates that the proximal clusters (or SVMs) for the host have not been configured. A value for the empty list results in normal operating system behavior for determining active-optimized (AO) and active non-optimized (ANO) paths, which are illustrated and described for FIGS. 7-9 and 12.

The list can contain the host records for clusters (or SVMs) and/or zero or more peer clusters (or SVMs) in different clusters. Prior to specifying peer clusters (or SVMs), a cluster (or SVMs) peering relationship is established between clusters (e.g., between first storage cluster having CG1 and a second storage cluster having a peered CG2). A list with one or more clusters (or SVMs) indicates that the proximal clusters (or SVMs) for the host (or initiator) have been configured. Any clusters (or SVMs) in the list are considered proximal. At operation 1104, paths from a host to proximal clusters (or SVMs) will be advertised as active optimized (AO) (e.g., if the paths would normally be AO amongst the clusters nodes). Any clusters (or SVMs) not in the list are considered remote. At operation 1106, paths from a host to remote clusters (or SVMs) are intended as non-preferred/backup paths and will be advertised as active non-optimized (ANO). At operation 1108, users set proximal clusters property (e.g., proximal SVMs property) so the correct ALUA state can be reported and this improves IO access performance due to more frequently using AO paths when available and less frequently using ANO paths. Host (or initiator) proximity can be set before a host has been added to a host group. If the host record does not yet exist, it will be created. Host proximity can be modified any time thereafter. A proximity setting for a host applies to all instances of the host in all host groups within the same cluster (or SVM). The proximity setting is meaningful when included in a host group mapped to a LUN in a load-balancing CG relationship; at other times, the proximity setting can be ignored.

At operation 1110, the proximal clusters (e.g., proximal SVMs) for all hosts will be replicated to peer clusters (or peer SVMs) so that both clusters of a load-balancing relationship have a deterministic and consistent view of host proximity. This will be used to determine ALUA value appropriately. In one example, host 1 is proximal to the first storage cluster of a first storage site. The first storage cluster sends this configuration information including the host proximity to a second storage cluster of the second storage site, which then automatically derives that host 1 is not proximal (remote) to the second storage cluster. In this case, host 2 is proximal to the second storage cluster, which sends this configuration information to the first storage cluster to automatically derive that host 2 is not proximal to the first storage cluster. This property applies only to hosts (or initiators) mapped to LUNs in load-balancing mode and is ignored for other LUN maps.

The present design accurately models the possible topographies for a host (or an initiator) by allowing the host to be proximal to multiple clusters. Host proximal cluster replication (or initiator proximal-SVMs replication) is simpler than host group replication due to host groups being a much more complex object.

Pre-existing host groups with a mix of proximal and remote initiators no longer need to be split to transition to a load-balancing mode. Load-balancing LUNs can now still report proper ALUA values without requiring replicated host groups, removing a restriction from the user. There is no longer confusion/complexity over the configuration of a host (or an initiator) compared to when the configuration came from the host's host group and the host was in multiple host groups.

Multiple (e.g., two or more clusters, three clusters, etc.) clusters can have peering relationships with overlapping hosts and configure for ALUA properly. This was not possible when the configuration of a remote host was flipped during host group replication. SCSIT no longer has to make assumptions about what the peer cluster will be reporting for ALUA. Both first and second storage clusters will utilize the same replicated source configuration for hosts and each host has only one possible value relative to a cluster. Modifying the host configuration for existing hosts causes setting the proximal path for hosts on the local Cluster. Host replication will effectively inverse the host proximity on the remote cluster.

In this present design, modifying the host configuration is non-disruptively configurable and modifiable causing no loss of access to hosts due to not having to tear down any LUN mappings for the configuration change.

A block of storage is carved out of a larger pool and designated as a LUN for LUN creation of a LUN mapping process. The host's information, including its initiator (e.g., its WWN or iSCSI IQN), is defined within the storage system. The LUN is then “mapped” to the host, essentially creating a link between the LUN and host. After mapping, the LUN becomes visible to the specified host, which can then access and use it for its operations.

Mapping controls which hosts can see which LUNs from the storage system's perspective. A specific LUN number can be assigned to a LUN when it's presented to a host, which is useful for consistent configuration. By mapping LUNs to specific hosts, you prevent other servers from accessing them, which is a security feature. Mapping allows administrators to allocate specific storage resources to the hosts that need them.

For Non-uniform configuration, a new host group has to be created if a host group doesn't exist and Map existing LUNs to this host group.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium (or non-transitory computer-readable medium) may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 12 is a block diagram illustrating a virtualized environment of a symmetric Active/Active storage system in which various embodiments may be implemented (e.g., virtual storage nodes of a primary storage site, a secondary storage site, etc.). In various examples described herein, a virtual storage system 1200 may be run (e.g., on a VM or as a containerized instance, as the case may be) within a public cloud provider. In the context of the present example, the virtual storage system 1200 includes a management server appliance 1210, a host clustering 1220 that includes host 01 and a host 02, VM migration 1221, and clusters 01 and 02. Cluster 01 includes a consistency group 1240 with LUNs L1, L2, and L3 (or NVMe namespace). Cluster 02 includes a consistency group 1250 with LUNs L1, L2, and L3 (or NVMe namespace).

To create a virtualized high availability host clustering 1220 across two sites A and B, hosts are used and managed by a server appliance 1210. The virtual machine (VM-1) can be migrated from host 01 to host 02. The server appliance 1210 is a centralized management system that enables administrators to effectively operate hosts in host clusters. The server appliance 1210 facilitates key functions such as VM provisioning, High Availability (HA), Distributed Resource Scheduler (DRS), Kubernetes Grid, and more.

The virtual storage system 1200 provides advanced business continuity if one or more failure domains suffer a total outage. The virtual storage system 1200 may present storage over a network to clients using various protocols (e.g., object storage protocol (OSP), small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients may request services of the virtual storage system 1200 by issuing Input/Output requests (e.g., file system protocol messages (in the form of packets) over the network). A representative client may comprise an application, such as a database application, executing on a computer that “connects” to the virtual storage system over a computer network, such as a point-to-point channel, a shared local area network (LAN), a wide area network (WAN), or a virtual private network (VPN) implemented over a public network, such as the Internet.

In the context of the present example, the clusters 01 and 02 each include virtual storage nodes with each virtual storage node including an operating system. The storage nodes can include storage device drivers for transmission of messages and data via the one or more links 1241 and 1242.

The data served by the virtual storage nodes may be distributed across multiple storage units embodied as persistent storage devices (e.g., non-volatile memory), including but not limited to HDDs, SSDs, flash memory systems, or other storage devices.

The clusters 01 and 02 enable business services to continue operating even through a complete site failure, supporting applications to fail over transparently using a secondary copy. Neither manual intervention nor custom scripting are required to trigger a failover with active sync. The active sync supports a symmetric active active capability, enabling read and write I/O operations from both copies of a protected LUN (e.g., L1, L2, L3) with bidirectional synchronous replication, enabling both LUN copies to serve I/O operations locally.

A host proximity feature of the operating system sets a host proximity for hosts 01 and 02 to provide an ability to configure the storage systems to know where the hosts are located with respect to storage clusters. When LUNs are mapped to a given host, an admin can indicate whether or not the host is proximal to a given storage system. Proximity refers to a per-cluster configuration that indicates a particular host WWN or iSCSI (Internet Small Computer System Interface) initiator ID belongs to a local host. Each LUN (or NVMe namespace) must be mapped to a host group that contains the WWN/iSCSi IDs of the hosts that need access to that LUN (or NVMe namespace). This controls which host has access to a LUN. A second, optional step is to configure host proximity. This does not control access, it controls priority.

For example, the host 01 at site A might be configured to access a LUN (or NVMe namespace) that is protected by bi-directional active active synchronous replication, and since the SAN is extended across sites, paths are available to that LUN or NVMe namespace) using storage on site A or storage on site B. Without proximity settings, the host 01 will use both cluster 01 and cluster 02 storage systems equally because both storage systems will advertise active/optimized paths. If the SAN latency and/or bandwidth between sites is limited, this may not be desireable, and the admin may wish to ensure that during normal operation each host preferentially uses paths to the local storage system. This is configured by adding the host WWN/iSCSI ID to the local cluster as a proximal host. This can be done at the command line interface (CLI) or a System Manager of the operating system.

In normal operation, all IO is local IO. Reads and writes are serviced from the local storage array. Write IO will, of course, also need to be replicated by the local controller to the remote system before being acknowledged, but all read IO will be serviced locally and will not incur extra latency by traversing the SAN link between sites. However, the non-optimized paths will be used when all active/optimized paths lose connection. For example, if the entire array on site A lost power, the hosts at site A would still be able to access paths to the array on site B and therefore remain operational, although the hosts would be experiencing higher latency. There are redundant paths through the local cluster that are not shown on these diagrams for the sake of simplicity. The storage systems are HA, so a controller failure should not result in site failure. The site failure should merely result in a change in which local paths are used on the affected site.

A data protection relationship to protect for business continuity is created between the source storage system (e.g., cluster 01) and destination storage system (e.g., cluster 02), by adding the application specific LUNs (or NVMe namespace) from different volumes within a storage virtual machine (SVM) to the consistency group. Under normal operations, the enterprise application writes to the primary consistency group (e.g., CG 1240), which synchronously replicates this I/O to the mirror consistency group (e.g., CG 1250). Even though two separate copies of the data exist in the data protection relationship, because active sync maintains the same LUN identity, the application host sees this as a shared virtual device with multiple paths (e.g., active/optimized paths 1222, 1223; active/non-optimized path 1225, 1226) while only one LUN copy is being written to at a time.

Active Optimized paths are a path state in ALUA (Asymmetric Logical Unit Access) where the target storage system responds to I/O requests using the most efficient path. In this case, the active/optimized path 1222 is between host 01 and cluster 01 at site A while the active/optimized path 1223 is between host 02 and cluster 02 at site B. The active non-optimized paths 1225 and 1226 are between different sites. This results in higher performance and reduced latency.

When a failure renders the primary storage system offline, the operating system detects this failure and uses the Mediator 1290 for reconfirmation. If neither the operating system nor the Mediator 1290 are able to ping the primary site with cluster 01, the operating system performs the automatic failover operation. This process results in failing over only a specific application without the need for the manual intervention or scripting which was previously required for the purpose of failover.

The external Mediator 1290 is external from sites A and B and installed in a third failure domain, distinct from the two distinct failure domains of the clusters 01 and 02. The Mediator 1290 acts as a passive witness to active sync copies. In the event of a network partition or unavailability of one copy, active sync uses Mediator 1290 to determine which copy continues to serve I/O, while discontinuing I/O on the other copy. The Mediator 1290 plays a crucial role in active sync configurations as a passive quorum witness, ensuring quorum maintenance and facilitating data access during failures. It acts as a ping proxy for controllers to determine liveliness of peer controllers. Although the Mediator does not actively trigger switchover operations, it provides a vital function by allowing the surviving node to check its partner's status during network communication issues. In its role as a quorum witness, the Mediator provides an alternate path (effectively serving as a proxy) to the peer cluster.

Furthermore, the Mediator allows clusters to get this information as part of the quorum process. The Mediator 1290 utilizes the node management LIF and cluster management LIF for communication purposes. The Mediator 1290 establishes redundant connections through multiple paths to differentiate between site failure and InterSwitch Link (ISL) failure. When a cluster loses connection with the Mediator software and all its nodes due to an event, it is considered not reachable. This triggers an alert and enables automated failover to the mirror Consistency Group (CG) in the secondary site, ensuring uninterrupted I/O for the client. The replication data path relies on a heartbeat mechanism, and if a network glitch or event persists beyond a certain period, it can result in heartbeat failures, causing the relationship to go out-of-sync. However, the presence of redundant paths, such as LIF failover to another port, can sustain the heartbeat and prevent such disruptions.

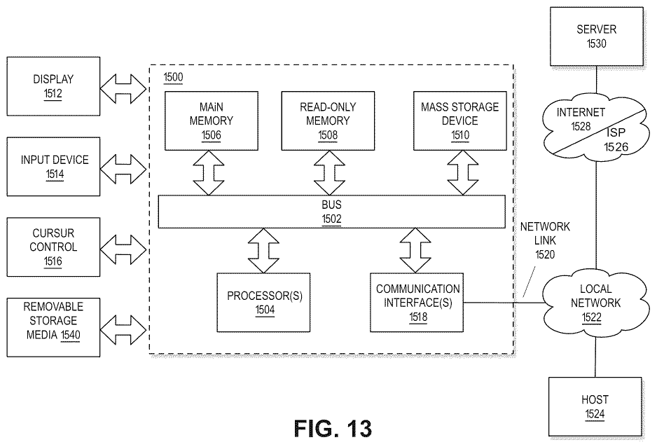

FIG. 13 is a block diagram that illustrates a computer system 1500 in which or with which an embodiment of the present disclosure may be implemented. Computer system 1500 may be representative of all or a portion of the computing resources associated with a storage node (e.g., storage node 136a-n, storage node 146a-n, storage node 156a-b, storage node 236a-n, storage node 246a-n, nodes 311-312, nodes 321-322, nodes 356a-356b, storage node 400, storage nodes N1-N4, storage nodes N5-N8), a mediator (e.g., mediator 120, mediator 220, mediator 360), or an administrative workstation (e.g., computer system 110, computer system 210). Notably, components of computer system 1500 described herein are meant only to exemplify various possibilities. In no way should example computer system 1500 limit the scope of the present disclosure. In the context of the present example, computer system 1500 includes a bus 1502 or other communication mechanism for communicating information, and a processing resource (e.g., processing logic, hardware processor(s) 1504) coupled with bus 1502 for processing information. Hardware processor 1504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, e.g., a magnetic disk, optical disk or flash disk (made of flash memory chips), is provided and coupled to bus 1502 for storing information and instructions.

Computer system 1500 may be coupled via bus 1502 to a display 1512, e.g., a cathode ray tube (CRT), Liquid Crystal Display (LCD), Organic Light-Emitting Diode Display (OLED), Digital Light Processing Display (DLP) or the like, for displaying information to a computer user. An input device 1514, including alphanumeric and other keys, is coupled to bus 1502 for communicating information and command selections to processor 1504. Another type of user input device is cursor control 1516, such as a mouse, a trackball, a trackpad, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Removable storage media 1540 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1500 may implement the techniques described herein using customized hard-wired logic, one or more ASICs or FPGAs, firmware or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1510. Volatile media includes dynamic memory, such as main memory 1506. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, a non-transitory computer-readable storage medium, any other memory chip or cartridge, or any storage device.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518. The received code may be executed by processor 1504 as it is received, or stored in storage device 1510, or other non-volatile storage for later execution.

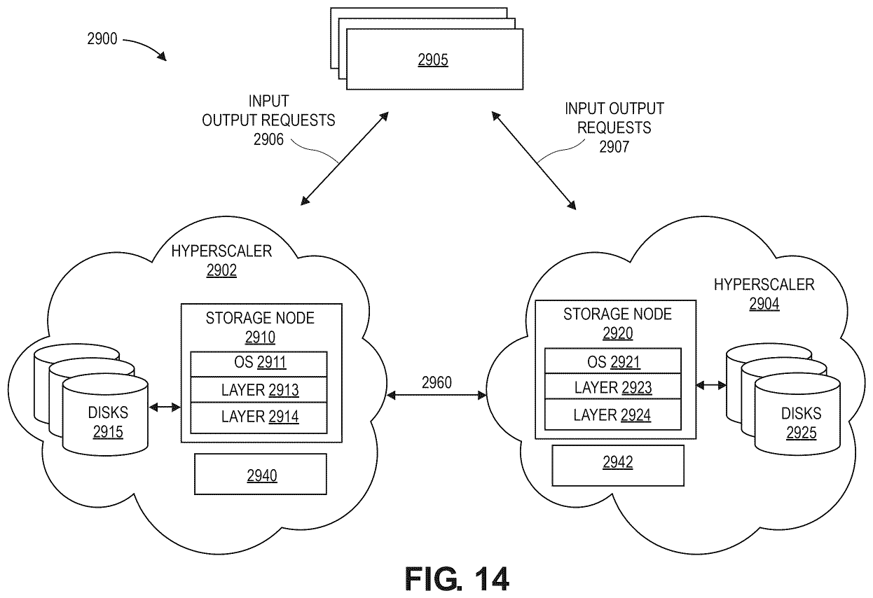

FIG. 14 is a block diagram illustrating a cloud environment in which various embodiments may be implemented (e.g., virtual storage nodes of a primary storage site, a secondary storage site, and a tertiary storage site). In various examples described herein, a virtual storage system 2900 may be run (e.g., on a VM or as a containerized instance, as the case may be) within a public cloud provider (e.g., hyperscaler 2902, 2904). In the context of the present example, the virtual storage system 2900 includes virtual storage nodes 2910 and 2920 and makes use of cloud disks (e.g., hyperscale disks 2915, 2925) provided by the hyperscaler. The virtual storage nodes 2910 and 2920 can perform operations of methods of the present disclosure such as operations illustrated in FIGS. 10-11.

The virtual storage system 2900 may present storage over a network to clients 2905 using various protocols (e.g., object storage protocol (OSP), small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 2905 may request services of the virtual storage system 2900 by issuing Input/Output requests 2906, 2907 (e.g., file system protocol messages (in the form of packets) over the network). A representative client of clients 2905 may comprise an application, such as a database application, executing on a computer that “connects” to the virtual storage system over a computer network, such as a point-to-point channel, a shared local area network (LAN), a wide area network (WAN), or a virtual private network (VPN) implemented over a public network, such as the Internet.

In the context of the present example, the virtual storage system 2900 includes virtual storage nodes 2910 and 2920 with each virtual storage node being shown includes an operating system. The virtual storage node 2910 includes an operating system 2911 having layers 2913 and 2914 for processing of operations or requests (e.g., object storage protocol operations or requests).

The virtual storage node 2920 includes an operating system 2921 having layers 2923 and 2924 for processing of operations or requests (e.g., object storage protocol operations or requests).

The storage nodes can include storage device drivers for transmission of messages and data via the one or more links 2960. The storage device drivers interact with the various types of hyperscale disks 2915, 2925 supported by the hyperscalers.

The data served by the virtual storage nodes may be distributed across multiple storage units embodied as persistent storage devices (e.g., non-volatile memory 2940, 2942), including but not limited to HDDs, SSDs, flash memory systems, or other storage devices (e.g., 2915, 2925).

Some embodiments relate to Example 1 that includes a computer-implemented method performed by one or more processing resources of a distributed storage system. The computer-implemented method comprises establishing, with one or more processing resources, a first consistency group (CG1) of a first storage cluster of a first storage site and a peered consistency group (CG2) of a second storage cluster of a storage site to provide synchronous replication between one or more members of CG1 and one or more members of CG2, specifying Hosts of a host group by adding hosts for the first storage cluster and the second storage cluster, and providing a host proximity property to a host record to identify one or more clusters to which a host is proximal.

Example 2 includes the subject matter of Example 1, further comprising providing an option to edit host proximity and host group replication; and setting host proximity so a correct port state and access characteristics can be reported to improve input output (IO) access performance.

Example 3 includes the subject matter of any of Examples 1-2, wherein the host proximity property for a first host includes a list with the first storage cluster to indicate that the first storage cluster has been configured as proximal to the first host.

Example 4 includes the subject matter of any of Examples 1-3, further comprising advertising, to one or more client devices, paths from the first host to the first storage cluster as active optimized (AO) and any storage clusters not in the list are considered remote; and advertising, to one or more client devices, paths from the first host to the second storage cluster as active non-optimized (ANO).

Example 5 includes the subject matter of any of Examples 1-4, further comprising replicating host group and host proximity information from the first storage cluster to the second storage clusters so that both of the first and second storage clusters have a deterministic and consistent view of host proximity; and determining port state and access characteristics based on the host proximity information.

Example 6 includes the subject matter of any of Examples 1-5, further comprising automatically deriving that the first host is not proximal to the second storage cluster based on receiving the host proximity information from the first storage cluster.

Example 7 includes the subject matter of any of Examples 1-6, further comprising modifying configuration of the first host with the configuration being non-disruptively configurable and modifiable causing no loss of access to any host due to not having to remove any LUN mappings for a configuration change.

Some embodiments relate to Example 8 that includes a non-transitory computer-readable storage medium embodying a set of instructions, which when executed by one or more processing resources, cause the one or more processing resources to establish, with one or more processing resources, a first group of members of a first storage cluster of a first storage site and a peered second group of members of a second storage cluster of a second storage site to provide synchronous replication between one or more members of the first group and one or more members of the second group; specify Hosts of a host group by adding hosts for the first storage cluster and the second storage cluster; and provide a host proximity property to a host record to identify one or more clusters to which a host is proximal.

Example 9 includes the subject matter of Example 8, wherein the set of instructions, when executed by the one or more processing resources, cause the one or more processing resources to provide an option to edit host proximity and host group replication and set host proximity so a correct port state and access characteristics can be reported to improve input output (IO) access performance.

Example 10 includes the subject matter of any of Examples 8-9, wherein the host proximity property for a first host includes a list with the first storage cluster to indicate that the first storage cluster has been configured as proximal to the first host.

Example 11 includes the subject matter of any of Examples 8-10, wherein the set of instructions, when executed by the one or more processing resources, cause the one or more processing resources to advertise, to one or more client devices, paths from the first host to the first storage cluster as active optimized (AO) and any storage clusters not in the list are considered remote; and advertise, to one or more client devices, paths from the first host to the second storage cluster as active non-optimized (ANO).

Example 12 includes the subject matter of any of Examples 8-11, wherein the set of instructions, when executed by the one or more processing resources, cause the one or more processing resources to replicate host group and host proximity information from the first storage cluster to the second storage clusters so that both of the first and second storage clusters have a deterministic and consistent view of host proximity; and determine port state and access characteristics based on the host proximity information.

Example 13 includes the subject matter of any of Examples 8-12, wherein the set of instructions, when executed by the one or more processing resources, cause the one or more processing resources to automatically derive that the first host is not proximal to the second storage cluster based on receiving the host proximity information from the first storage cluster.

Example 14 includes the subject matter of any of Examples 8-13, wherein the set of instructions, when executed by the one or more processing resources, cause the one or more processing resources to modify configuration of the first host with the configuration being non-disruptively configurable and modifiable causing no loss of access to any host due to not having to remove any LUN mappings for a configuration change.

Some embodiments of Example 15 relate to a distributed storage system including a first storage cluster having a first group of members of one or more storage nodes of a first storage site; a second storage cluster having a second group of members of one or more storage nodes of a second storage site; and one or more processing resources of the first or second storage cluster is configured to specify Hosts of a host group by adding hosts for the first storage cluster and the second storage cluster and provide a host proximity property to a host record to identify one or more storage clusters of the first and second storage clusters to which a host is proximal.

Example 16 includes the subject matter of Example 15, wherein the one or more processing resources is further configured to provide an option to edit host proximity and host group replication and set host proximity so a correct port state and access characteristics can be reported to improve input output (IO) access performance.

Example 17 includes the subject matter of any of Examples 15-16, wherein the host proximity property for a first host includes a list with the first storage cluster to indicate that the first storage cluster has been configured as proximal to the first host.

Example 18 includes the subject matter of any of Examples 15-17, wherein the set of instructions, when executed by the one or more processing resources, cause the one or more processing resources to advertise, to one or more client devices, paths from the first host to the first storage cluster as active optimized (AO) and any storage clusters not in the list are considered remote and advertise, to one or more client devices, paths from the first host to the second storage cluster as active non-optimized (ANO).

Example 19 includes the subject matter of any of Examples 15-18, wherein the one or more processing resources is further configured to replicate host group and host proximity information from the first storage cluster to the second storage clusters so that both of the first and second storage clusters have a deterministic and consistent view of host proximity and determine port state and access characteristics based on the host proximity information.

Example 20 includes the subject matter of any of Examples 15-19, wherein the one or more processing resources is further configured to automatically derive that the first host is not proximal to the second storage cluster based on receiving the host proximity information from the first storage cluster.

What is claimed is:

1. A computer-implemented method comprising:
establishing, with one or more processing resources, a first consistency group (CG1) of a first storage cluster of a first storage site and a peered consistency group (CG2) of a second storage cluster of a second storage site to provide synchronous replication between one or more members of CG1 and one or more members of CG2;
specifying hosts of a host group by adding hosts for the first storage cluster and the second storage cluster; and
providing a host proximity property to a host record to identify one or more clusters to which a host is proximal.

2. The computer-implemented method of claim 1, further comprising:
providing an option to edit host proximity and host group replication; and
setting host proximity so a correct port state and access characteristics can be reported to improve input output (IO) access performance.

3. The computer-implemented method of claim 1, wherein the host proximity property for a first host includes a list with the first storage cluster to indicate that the first storage cluster has been configured as proximal to the first host.

4. The computer-implemented method of claim 3, further comprising:
advertising, to one or more client devices, paths from the first host to the first storage cluster as active optimized (AO) and any storage clusters not in the list are considered remote; and
advertising, to one or more client devices, paths from the first host to the second storage cluster as active non-optimized (ANO).

5. The computer-implemented method of claim 3, further comprising:
replicating host group and host proximity information from the first storage cluster to the second storage clusters so that both of the first and second storage clusters have a deterministic and consistent view of host proximity; and
determining port state and access characteristics based on the host proximity information.

6. The computer-implemented method of claim 5, further comprising:
automatically deriving that the first host is not proximal to the second storage cluster based on receiving the host proximity information from the first storage cluster.

7. The computer-implemented method of claim 3, further comprising:
modifying configuration of the first host with the configuration being non-disruptively configurable and modifiable causing no loss of access to any host due to not having to remove any LUN mappings for a configuration change.

8. A non-transitory computer-readable storage medium embodying a set of instructions, which when executed by one or more processing resources, cause the one or more processing resources to:
establish, with one or more processing resources, a first group of members of a first storage cluster of a first storage site and a peered second group of members of a second storage cluster of a second storage site;
specify Hosts of a host group by adding hosts for the first storage cluster and the second storage cluster; and
provide a host proximity property to a host record to identify one or more clusters to which a host is proximal.

9. The non-transitory computer-readable storage medium of claim 8, wherein the set of instructions, when executed by the one or more processing resources, cause the one or more processing resources to:
provide an option to edit host proximity and host group replication; and
set host proximity so a correct port state and access characteristics can be reported to improve input output (IO) access performance.

10. The non-transitory computer-readable storage medium of claim 8, wherein the host proximity property for a first host includes a list with the first storage cluster to indicate that the first storage cluster has been configured as proximal to the first host.

11. The non-transitory computer-readable storage medium of claim 8, wherein the set of instructions, when executed by the one or more processing resources, cause the one or more processing resources to:
advertise, to one or more client devices, paths from the first host to the first storage cluster as active optimized (AO) and any storage clusters not in the list are considered remote; and
advertise, to one or more client devices, paths from the first host to the second storage cluster as active non-optimized (ANO).

12. The non-transitory computer-readable storage medium of claim 8, wherein the set of instructions, when executed by the one or more processing resources, cause the one or more processing resources to:
replicate host group and host proximity information from the first storage cluster to the second storage clusters so that both of the first and second storage clusters have a deterministic and consistent view of host proximity; and
determine port state and access characteristics based on the host proximity information.

13. The non-transitory computer-readable storage medium of claim 8, wherein the set of instructions, when executed by the one or more processing resources, cause the one or more processing resources to:
automatically derive that the first host is not proximal to the second storage cluster based on receiving the host proximity information from the first storage cluster.

14. The non-transitory computer-readable storage medium of claim 8, wherein the set of instructions, when executed by the one or more processing resources, cause the one or more processing resources to:
modify configuration of the first host with the configuration being non-disruptively configurable and modifiable causing no loss of access to any host due to not having to remove any LUN mappings for a configuration change.

15. A distributed storage system, comprising:
a first storage cluster having a first group of members of one or more storage nodes of a first storage site;
a second storage cluster having a second group of members of one or more storage nodes of a second storage site; and
one or more processing resources of the first storage cluster or the second storage cluster is configured to specify Hosts of a host group by adding hosts for the first storage cluster and the second storage cluster and provide a host proximity property to a host record to identify one or more storage clusters of the first and second storage clusters to which a host is proximal.

16. The distributed storage system of claim 15, wherein the one or more processing resources is further configured to:
provide an option to edit host proximity and host group replication; and
set host proximity so a correct port state and access characteristics can be reported to improve input output (IO) access performance.

17. The distributed storage system of claim 15, wherein the host proximity property for a first host includes a list with the first storage cluster to indicate that the first storage cluster has been configured as proximal to the first host.

18. The distributed storage system of claim 15, wherein the set of instructions, when executed by the one or more processing resources, cause the one or more processing resources to:
advertise, to one or more client devices, paths from the first host to the first storage cluster as active optimized (AO) and any storage clusters not in the list are considered remote; and
advertise, to one or more client devices, paths from the first host to the second storage cluster as active non-optimized (ANO).

19. The distributed storage system of claim 8, wherein the one or more processing resources is further configured to:
replicate host group and host proximity information from the first storage cluster to the second storage clusters so that both of the first and second storage clusters have a deterministic and consistent view of host proximity; and
determine port state and access characteristics based on the host proximity information.

20. The distributed storage system of claim 8, wherein the one or more processing resources is further configured to:
automatically derive that the first host is not proximal to the second storage cluster based on receiving the host proximity information from the first storage cluster.
